(19) United States
(12) Patent Application Publication
(10) Pub. No.: US 2026/0301121 A1
(43) Pub. Date: Oct. 1, 2026

(54) Method and Apparatus of ROI-based Image Restoration

(71) Applicant: Mediatek Inc., Hsinchu City (TW)

(72) Inventors: Chia-Hung Yuan, Hsinchu City (TW); Po-Heng Chen, Hsinchu City (TW); Sheng-Po Kuo, Hsinchu City (TW); Yi-Syuan Chen, Hsinchu City (TW); Tzu-Yin Wei, Hsinchu City (TW); Chi-Wei Hsiao, Hsinchu City (TW); Chia-Ping Chen, Hsinchu City (TW)

(73) Assignee: Mediatek Inc., Hsinchu City (TW)

(21) Appl. No.: 19/095,062

(22) Filed: Mar. 31, 2025

(51) Int. Cl. G06T 5/50; G06T 5/70; G06T 7/55; G06T 7/73

(52) U.S. Cl. CPC G06T 5/50; G06T 5/70; G06T 7/55; G06T 7/73; G06T 2207/20221

(57) ABSTRACT

A method of image processing performed by a processor, includes extracting at least one region of interest (ROI) from an image, performing image restoration processing on the extracted at least one ROI to generate at least one restored ROI, generating at least one fusion mask according to the at least one ROI, and performing fusion of the at least one restored ROI with remaining regions using the at least one fusion mask to generate a fused image. Regions of the image outside the at least one ROI are the remaining regions.

### BACKGROUND

Image or video restoration techniques can be used to enhance the quality of digital content. These techniques may employ various processing methods, including neural networks and other computational approaches, to improve visual characteristics of images and videos. The processing of digital content may involve different computational resources depending on the specific enhancement methods being applied.

Different regions within images or video may have varying levels of visual importance to viewers. For example, in video conferencing applications, certain portions of frames may be of greater interest than others. Similarly, in photography applications, particular areas of images may require different processing considerations than others.

Conventional approaches to image and video restoration typically process the entire full-resolution image or video frame. This full-resolution processing methodology, while straightforward, presents significant challenges in terms of computational resource utilization. When applying complex methods, particularly those involving neural networks or other artificial intelligence techniques, the processing of full-resolution content requires extensive computational resources. This resource-intensive approach can lead to increased processing time, higher power consumption, and potential limitations in real-time applications.

There is therefore a need for an improved method and apparatus for image and video restoration that can effectively balance computational efficiency with output quality while maintaining natural appearance and providing scalability for various application requirements.

### SUMMARY

An embodiment provides a method of image processing performed by a processor. The method comprises extracting at least one region of interest (ROI) from an image, performing image restoration processing on the extracted at least one ROI to generate at least one restored ROI, generating at least one fusion mask according to the at least one ROI, and performing fusion of the at least one restored ROI with a remaining region using the at least one fusion mask to generate a fused image. There is at least one region of the image outside the at least one ROI being the remaining region, and the remaining region are maintained without restoration processing.

An embodiment provides an image processing apparatus. The image processing apparatus comprises one or more processors configured to extract at least one region of interest (ROI) from an image, perform image restoration processing on the extracted at least one ROI to generate at least one restored ROI, generate at least one fusion mask according to the at least one ROI, and perform fusion of the at least one restored ROI with a remaining region using the at least one fusion mask to generate a fused image. There is at least one region of the image outside the at least one ROI being the remaining region, and the remaining region is maintained without restoration processing.

To the accomplishment of the foregoing and related ends, certain embodiments comprise the features hereinafter fully described and particularly pointed out in the claims. The following description and accompanying drawings set forth in detail certain illustrative aspects of the embodiments. These aspects are indicative, however, of but a few of the various ways in which the principles of the embodiments may be employed, and the present disclosure is intended to include all such aspects and their equivalents. These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 depict image restoration processes that employ ROI processing with content smart fusion according to an embodiment.

FIG. 3 depicts an image restoration process that handles multiple ROIs according to an embodiment.

FIG. 4 depicts an image restoration process that implements alpha-based fusion masking according to an embodiment.

FIG. 5 depicts an image restoration process that incorporates domain-specific processing according to the embodiment.

FIG. 6 depicts an image restoration process that employs a multi-resolution pyramid approach according to an embodiment.

FIG. 7 depicts an image restoration process that implements spatial smoothing techniques according to an embodiment.

FIG. 8 depicts an image restoration processing that handles temporal smoothing in video sequences.

FIG. 9 is a flowchart illustrating a method of image processing according to the embodiments.

FIG. 10 is a flowchart illustrating an alternative method of image processing according to the embodiments.

FIG. 11 depicts a block diagram of an image processing apparatus according to the embodiments.

### DETAILED DESCRIPTION

The present disclosure provides a detailed description of various embodiments. While specific implementation details are presented herein to facilitate a comprehensive understanding of the disclosure, it will be apparent to those skilled in the art that the present invention may be realized without necessarily adhering to all such particularities. In certain instances, well-established methods, procedures, components, and circuits have been omitted from exhaustive description to avoid obscuring the present disclosure. It should be understood that technical features individually described in relation to a single drawing may be implemented either discretely or in combination with other features, as set forth in the present specification.

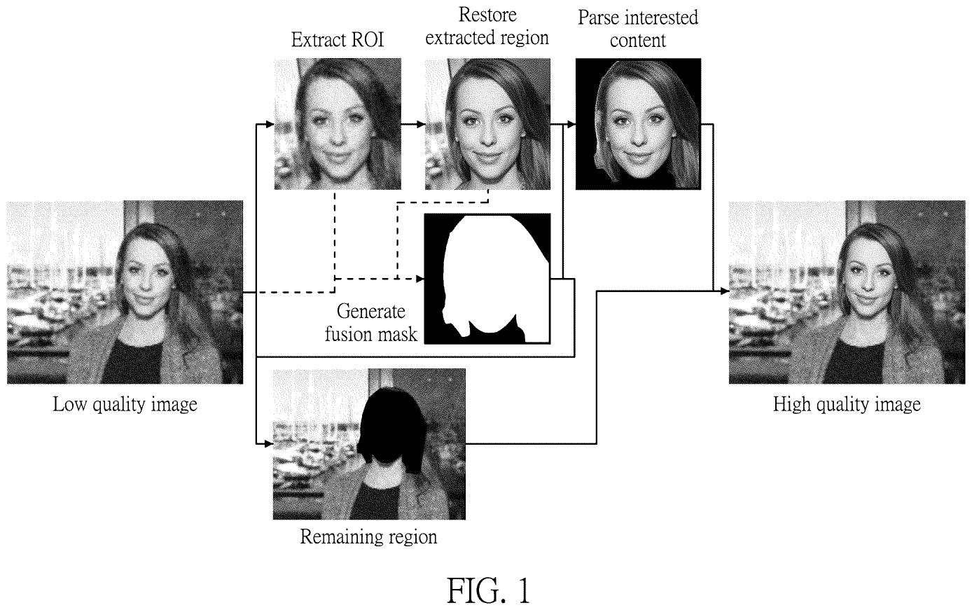

FIG. 1 depicts an image restoration process that employs region of interest (ROI) processing with content smart fusion according to an embodiment of the present invention. The process includes several key steps that work together to achieve efficient and high-quality image restoration.

In the first processing step, an ROI extraction operation is performed on an input low quality (LQ) image. The ROI extraction identifies and isolates specific regions within the image that require restoration processing. This targeted approach enables more efficient use of computational resources by focusing processing efforts on the most important areas of the image.

Following ROI extraction, another processing path is implemented. In this path, the extracted ROI undergoes restoration processing. This restoration processing is specifically applied to the extracted region, significantly reducing the computational overhead compared to full-image restoration approaches. The restoration processing generates a higher quality version of the ROI content.

After restoration of the extracted ROI region, a parsing operation is performed to analyze the interested content within the context of the image on both the ROI region and the remaining region. This parsing operation provides essential information about the image content that will be used to guide the fusion process. The parsing step identifies relevant features and characteristics that help determine how the restored ROI should be combined with the remaining image regions. Based on the parsed content information, a fusion mask is generated through a content smart fusion mask generation process. This fusion mask is specifically designed to enable smooth and natural integration of the restored ROI with the remaining regions of the image. The mask generation takes into account the content characteristics identified during the parsing step to create appropriate blending boundaries.

In various embodiments, the fusion mask may be derived from one or more of the following: the low quality image, the low quality ROI, or the restored ROI. The sources for fusion mask generation described herein are exemplary and non-limiting.

The remaining region of the original low-quality image, which has not undergone restoration processing, can be maintained and prepared for the fusion process. This region serves as the background or context into which the restored ROI will be integrated.

In the final processing step, a fusion operation is performed using the generated fusion mask. This operation combines the restored ROI with the remaining region to generate a high quality (HQ) output image. The fusion process, guided by the content smart mask, ensures that the transition between the restored and non-restored regions appears natural and seamless.

A key advantage of this embodiment is that it achieves high-quality restoration while minimizing computational resources through targeted processing of the ROI. Additionally, the content smart fusion approach ensures that the final result maintains visual continuity and natural appearance across the entire image, avoiding artificial-looking boundaries or discontinuities between processed and unprocessed regions.

The low cost computational advantage is achieved by limiting the expensive restoration processing to the ROI portion of the image, while the content smart fusion ensures that this selective processing does not compromise the overall visual quality of the final output. This approach provides an effective balance between processing efficiency and output quality.

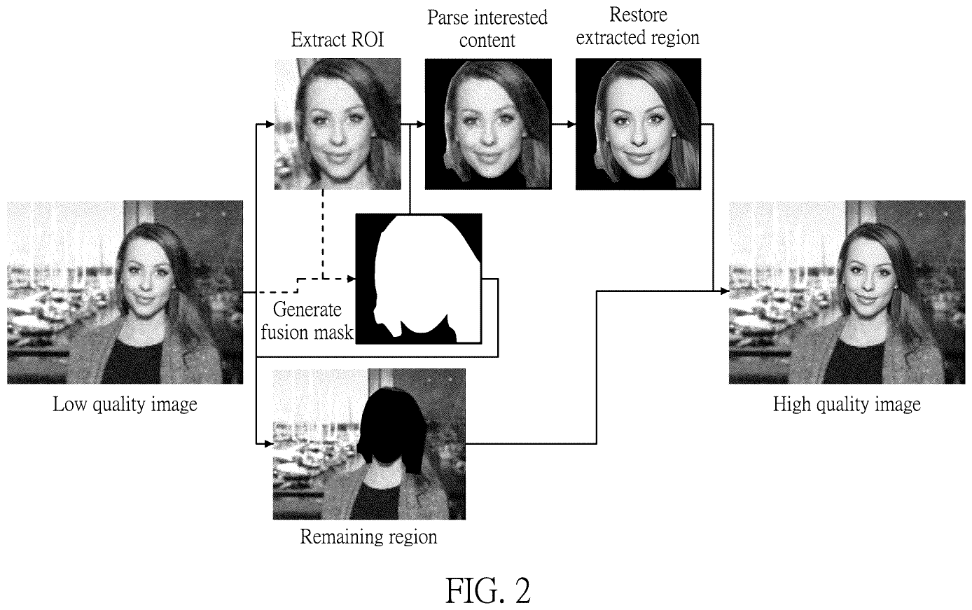

FIG. 2 depicts an image restoration process that employs ROI processing with content smart fusion according to another embodiment. In this embodiment, an alternative method for image restoration is provided that implements a modified processing flow while maintaining the core benefits of ROI-based processing and content smart fusion.

The process begins with ROI extraction from an input low quality (LQ) image, similar to the previous embodiment. This extraction step identifies and isolates the specific regions that will undergo specialized processing for quality enhancement.

Following the ROI extraction, this embodiment implements a series of sequential processing steps that are specifically organized to optimize the handling of the interested content. After the ROI is extracted, a parsing operation is performed to analyze the interested content within the ROI. This parsing step occurs before the restoration processing, which differs from processing approach described in the previous embodiment. By performing the parsing operation first, the system may better understand the content characteristics before applying restoration algorithms.

Once the content has been parsed and analyzed, a fusion mask is generated through a content smart fusion mask generation process. The early generation of the fusion mask allows the system to plan the restoration and integration strategy based on the specific content characteristics identified during parsing. This sequencing helps ensure that the restoration process can be optimized for the particular content type and fusion requirements. After the fusion mask has been generated, the restoration method is applied to the extracted region, in which the restoration processing is specifically tailored to the parsed content and fusion requirements, as the system already has information about how the restored content will need to be integrated with the remaining image regions.

Concurrent with these operations, the remaining region of the original low quality image is maintained separate from the restoration processing pipeline. This remaining region will serve as the base into which the restored content will be integrated.

The final step involves a fusion operation that combines the restored ROI with the remaining region to produce a high quality (HQ) output image. The fusion process utilizes the previously generated content smart mask to ensure smooth and natural integration of the restored content.

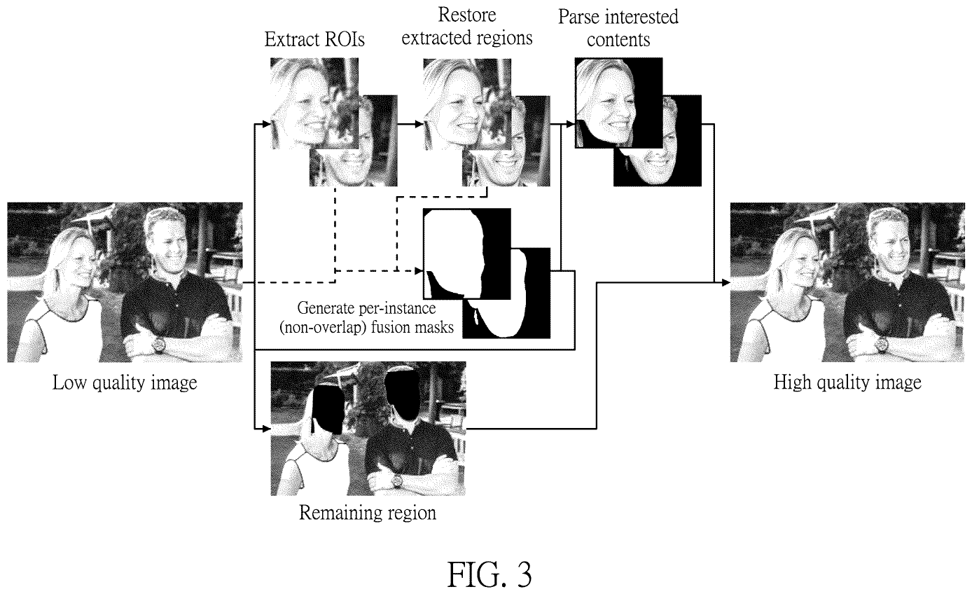

FIG. 3 depicts an image restoration process that handles multiple ROIs according to an embodiment. This embodiment emphasize particularly on processing multiple instances such as faces within an image and their subsequent fusion.

The process begins with a multiple ROI extraction operation performed on an input low quality (LQ) image. Unlike previous embodiments that may focus on a single ROI, this embodiment is specifically designed to identify and extract multiple ROIs simultaneously. For example, in a group photograph, the system may identify and extract multiple faces as separate ROIs, each requiring individual restoration processing.

Following the extraction of multiple ROIs, the process implements a multi-instance processing approach. Each extracted ROI undergoes individual restoration processing, allowing for specialized treatment of each region based on its specific characteristics. This parallel restoration processing of multiple ROIs enables efficient handling of complex scenes with multiple areas of interest.

After the restoration processing, a content parsing operation is performed for each ROI. Again, this parsing step analyzes the specific content characteristics of each instance, such as facial features, orientations, lighting conditions, and other relevant attributes that may affect the restoration and fusion processes.

A key innovation in this embodiment is the generation of instance-specific fusion masks. Rather than creating a single fusion mask for the entire image, the system generates individual, non-overlapping fusion masks for each ROI or each group of ROI. These per-instance fusion masks are designed to prevent interference between adjacent ROIs or ROI groups while ensuring smooth integration with the surrounding image content. For example, when processing multiple faces in a group photo as shown in FIG. 3, each face would have its own specific fusion mask that accounts for the unique characteristics and boundaries of that facial region. In some other embodiments, one or more ROIs may be taken as an ROI group and may correspond to a same per-instance fusion mask.

In various embodiments, the fusion mask may be derived from one or more of the following: the low quality image, the low quality ROI, or the restored ROI. The sources for fusion mask generation described herein are exemplary and non-limiting.

In addition, the instance-specific fusion masks can be depth-aware. For each extracted ROI, the system may generate a unique fusion mask that accounts for both spatial boundaries and depth position of the ROI in the scene. These instance-specific fusion masks are designed to be non-overlapping in both spatial and depth dimensions, ensuring clear separation between different ROIs while maintaining their depth-based relationships.

In the case of multiple ROIs, the necessity of non-overlapping fusion masks is fundamentally dependent on the availability of depth information in the image. When depth information is accessible, the fusion process can be systematically executed from far to near, following the natural spatial arrangement of objects in the scene. Under these circumstances, even overlapping fusion masks can be effectively utilized without causing significant issues, as the fusion order naturally follows the depth-based layering of objects, similar to real-world occlusion relationships. This approach maintains visual coherence as it mirrors the natural arrangement of objects in three-dimensional space.

However, in scenarios where depth information is unavailable, and fusion must be performed in an arbitrary order, the use of non-overlapping fusion masks becomes crucial. This is to prevent potential artifacts and inconsistencies that could arise from processing overlapping regions in an undefined order. Without depth information to guide the fusion sequence, overlapping masks could lead to multiple restorations of the same region, resulting in over-processing and visual artifacts that would vary depending on the arbitrary processing order. Therefore, the generation of non-overlapping fusion masks serves as a critical safeguard to ensure consistent and visually coherent results in the absence of depth-based ordering information.

The remaining region of the image, which comprises one or more areas not included in any ROI, is maintained separately. In some other embodiments, remaining region of the image, which comprises all areas not included in any ROI, is maintained separately. The remaining region serves as the common background into which all restored ROIs will be integrated.

A sophisticated fusion operation then combines all restored ROIs with the remaining region to produce a high quality (HQ) output image. This fusion process utilizes the per-instance fusion masks to ensure that each restored ROI is seamlessly integrated while maintaining proper spatial relationships and natural transitions between all elements of the image.

The fusion process is particularly sophisticated in its handling of multiple instances, incorporating several key features. It manages non-overlapping masks to prevent conflicts between adjacent ROIs. Additionally, it uses instance-specific blending parameters to account for the unique characteristics of each ROI. The process ensures coordinated fusion, maintaining consistent quality and appearance across all restored regions. Furthermore, it handles boundary conditions effectively, ensuring smooth transitions both between ROIs and with the surrounding unprocessed regions.

This instance-specific approach provides several distinct advantages. First, it enables efficient handling of complex scenes where multiple regions require enhancement, such as group photographs where multiple faces need to be restored. Second, the per-instance fusion masks allow for more precise control over the integration of each restored region, ensuring optimal results for each ROI while maintaining overall image coherence. Third, the parallel processing of multiple ROIs can be efficiently managed to optimize computational resources while still delivering high-quality results for each instance.

Furthermore, this embodiment demonstrates the scalability of the ROI-based restoration approach, showing how it can be effectively applied to scenarios involving multiple instances while maintaining the core benefits of computational efficiency and high-quality output. The ability of the system to handle multiple ROIs with individual fusion masks makes it particularly well-suited for applications involving group photos, crowd scenes, or any situation where multiple regions require independent but coordinated restoration processing.

While the described embodiment presents one sequence of operations, it should be understood that the content parsing and fusion mask generation may be performed prior to ROI restoration, as described in other embodiments. The specific timing and sequence of these operations may be varied without departing from the scope of the invention.

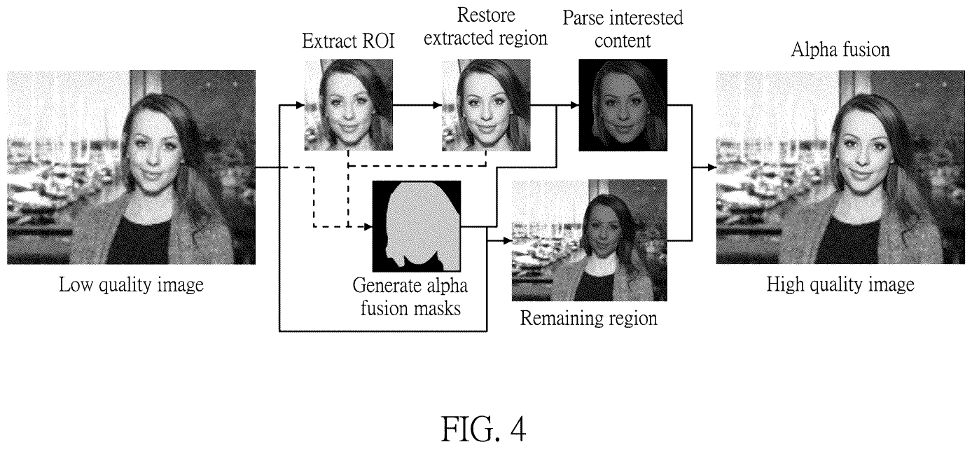

FIG. 4 depicts an image restoration process that implements alpha-based fusion masking according to an embodiment. This alpha fusion approach offers precise control over the blending process and enables smooth transitions between processed and unprocessed areas.

The alpha fusion mask represents a continuous-valued weight map that defines how the restored ROI should be blended with the remaining image regions. Each pixel in the alpha fusion mask contains a value typically ranging from 0 to 1, where 0 represents complete contribution from the unprocessed region, and 1 represents complete contribution from the restored ROI. This continuous-valued nature of the alpha mask enables smooth, gradual transitions that avoid visible boundaries or artifacts.

In scenarios involving multiple ROIs, the alpha fusion process implements a sophisticated approach to handle multiple regions while maintaining proper blending. Individual alpha masks are generated for each ROI, with non-overlapping constraints enforced to prevent conflicts. When regions are adjacent, mask values are carefully normalized to ensure smooth transitions, and global consistency is maintained across all fusion regions to preserve the overall visual coherence of the image.

When processing video sequences, the method implements temporal consistency measures to ensure stable and natural-looking results across frames. This includes temporal smoothing of alpha values to prevent flickering, motion-aware alpha mask generation that accounts for object movement, frame-to-frame consistency maintenance in transition regions, and preservation of temporal coherence in blending weights. These temporal considerations are crucial for maintaining visual stability in video applications.

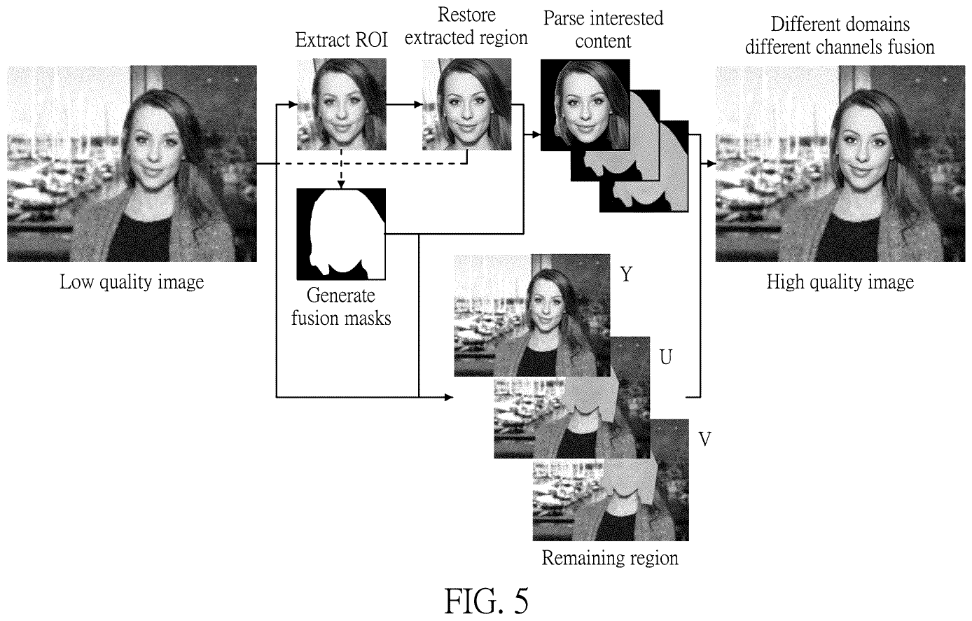

FIG. 5 depicts an image restoration process that incorporates domain-specific processing according to an embodiment. This embodiment particularly focuses on fusion operations performed across different color spaces and processing domains.

As one example implementation, the fusion process may be performed in the YUV color space domain. In this implementation, the system first extracts the region of interest (ROI) from the input low quality image. After the ROI extraction, the system performs restoration processing specifically on the extracted region. At this time, the system parses the interested content to generate appropriate fusion masks for the subsequent combination process.

In the YUV domain fusion approach, the system may selectively combine different channels from the restored and remaining regions. For instance, the Y (luminance) channel of the restored ROI may be combined with the U and V (chrominance) channels from the remaining region of the original image. This selective channel combination allows for more precise control over the fusion process, as different image characteristics can be preserved or enhanced based on their channel representation.

Following the channel-specific combination, the system performs a color space conversion, such as converting the combined YUV representation back to the RGB color space to generate the final high quality output image. This conversion ensures that the final output is in a suitable format for display or further processing while maintaining the benefits of the domain-specific fusion.

The domain fusion extends beyond simple YUV color space processing. The system may alternatively or additionally perform fusion operations in various other domains, including but not limited to frequency domain processing, where fusion may be performed on different frequency components of the image; hybrid domain processing, which may combine aspects of multiple processing domains; and custom color space domains optimized for specific types of content or restoration requirements.

Furthermore, the system supports combining different domain fusion approaches with alpha blending techniques. This hybrid approach allows for fine-tuned control over the fusion process, where different channels or components may be blended using different weights or methods according to the specific requirements of the application or content type.

This domain-specific fusion approach provides several advantages. Firstly, it has enhanced control over different aspects of the image during the fusion process while maintaining the ability to optimize the fusion operation for specific types of content or artifacts. Furthermore, there is the potential for improved computational efficiency by processing only relevant channels or components. In addition, this approach may better preservation of specific image characteristics through selective domain processing. Finally, the system maintains scalability in its domain fusion approach, allowing for dynamic adjustment of the fusion methods and domains.

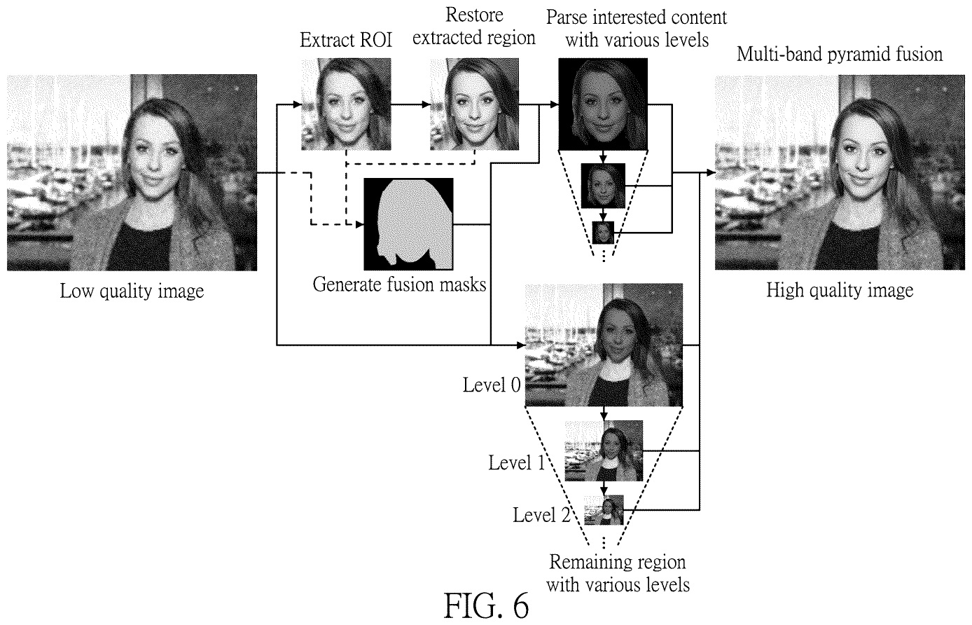

FIG. 6 depicts an image restoration process that employs a multi-resolution pyramid approach according to an embodiment. This embodiment utilizes a Laplacian pyramid structure to perform the fusion operation across different resolution levels, enabling more sophisticated and natural-looking results.

The pyramid-based fusion process begins with the extraction of the ROI from the input low quality image. Following the extraction, restoration processing is performed exclusively on the ROI portion to enhance its quality. Simultaneously, the system performs content parsing to understand the characteristics of both the ROI and the surrounding areas, which will guide the fusion process across different pyramid levels.

In implementing the pyramid fusion approach, the system first computes the Laplacian pyramid representations of both the restored ROI region and the remaining unprocessed region. The Laplacian pyramid decomposition creates a series of band-pass filtered images at different scales, effectively separating the image content into different frequency bands. This decomposition typically includes multiple levels, where each level represents image details at a different scale, from fine details at the highest level to coarse structures at the lower levels.

The fusion process then operates independently at each level of the Laplacian pyramids. At each level, the system generates appropriate fusion masks that are specifically tailored to the scale and content characteristics of that particular level. This level-specific processing allows for more precise control over how different scales of image detail are combined between the restored and unprocessed regions.

After the level-specific fusion operations are complete, the system reconstructs the final high quality output image from the fused pyramid representation. This reconstruction process combines the fused components from all pyramid levels to create a seamless final result. The multi-resolution nature of this approach helps to avoid artifacts that might occur when attempting to directly fuse regions at a single resolution level, as it allows for smooth transitions across different scales of image detail.

The pyramid-based fusion approach provides particularly effective results because it handles different scales of image structure separately, allowing for more natural blending of fine details, edges, and broader image structures between the restored and unprocessed regions. This multi-scale processing helps to preserve the continuity of image structures across the fusion boundary while maintaining the enhanced quality achieved through the ROI restoration process.

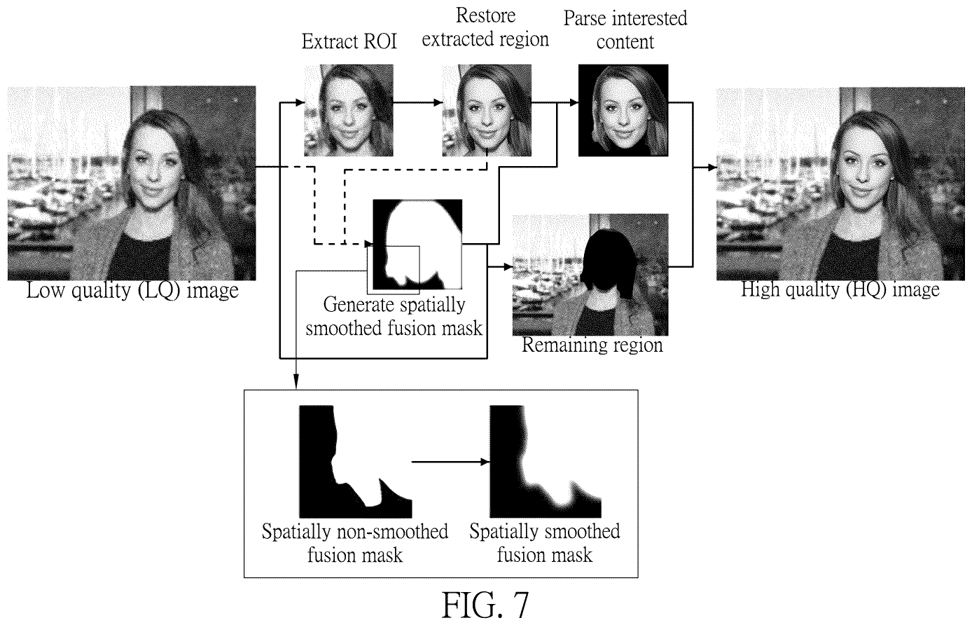

FIG. 7 depicts an image restoration process that implements spatial smoothing techniques according to an embodiment. This embodiment specifically addresses the challenge of maintaining natural transitions in the fusion boundaries by incorporating spatial smoothing operations into the fusion mask generation process.

The process begins with receiving a low quality image as input. From this input image, the system extracts a region of interest using ROI extraction techniques. The extracted ROI undergoes restoration processing to generate a higher quality version of the selected region, while the remaining regions of the image are maintained in their original state. Also, the system performs content parsing operations to analyze the interested content within the image, which provides essential information for generating appropriate fusion parameters.

A key aspect of this embodiment is the generation of spatially smoothed fusion masks. Rather than employing sharp or binary masks that could lead to visible boundaries between processed and unprocessed regions, the system generates fusion masks with spatially smoothed characteristics. These smoothed masks feature gradual transitions between the fully restored and unrestored regions, enabling more natural blending at the boundaries. The spatial smoothing operation may employ various smoothing algorithms or filters to achieve the desired transition characteristics, with the specific smoothing parameters potentially being adjusted based on the content characteristics and application requirements.

The final step involves using these spatially smoothed fusion masks to combine the restored ROI with the remaining regions, producing a high quality output image. The smoothed nature of the fusion masks ensures that the transition between restored and unrestored regions appears continuous and natural, avoiding any sharp or artificial-looking boundaries that might otherwise detract from the overall image quality. This approach enables the system to maintain the advantages of ROI-based processing while ensuring that the final output appears as a cohesive, naturally processed image.

It should be noted that the smoothing operation can be implemented through various approaches, including Gaussian smoothing of the mask boundaries, distance-based falloff functions, content-aware smoothing that considers image features, and edge-preserving smoothing to maintain important structural boundaries.

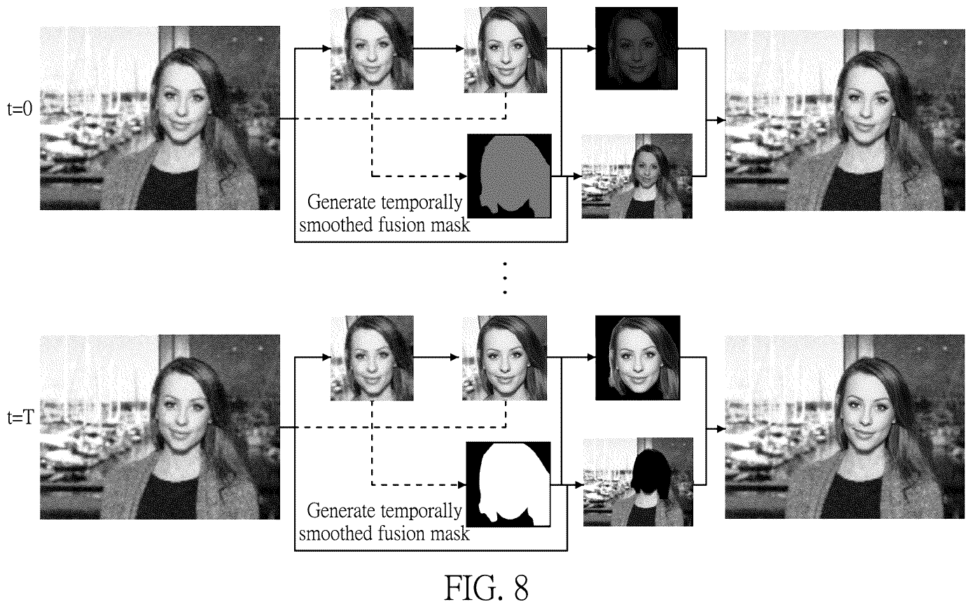

In yet another embodiment, the image restoration processing technique can be extended to handle temporal smoothing in video sequences, as depicted in FIG. 8. This embodiment addresses the challenges of maintaining consistency and natural transitions not only in spatial dimensions but also across consecutive frames in a video stream.

When processing video content, the system generates temporally smoothed fusion masks that evolve over time. The temporal smoothing process begins at an initial time step t=0 and continues through subsequent frames until a final time step t=T, where T represents the duration of the temporal transition. This approach is particularly useful for implementing effects such as fade-in transitions of restored regions, ensuring that the introduction of enhanced content appears natural and gradual within the video sequence.

On the other hand, fade-out transitions of restored regions, the temporal smoothing process begins at an initial time step t=T1 and continues through subsequent frames until a final time step t=T2. Note that T2−T1 represents the duration of the temporal transition.

For each frame in the video sequence, the system performs ROI extraction and restoration processing as in the base embodiment. However, the fusion mask generation process is modified to account for temporal relationships between consecutive frames. The temporally smoothed fusion masks are generated with consideration of both the current frame's content and the temporal context, including previous and subsequent frames in the sequence.

The temporal smoothing operation implements several sophisticated approaches to achieve optimal results. The system employs progressive weight adjustment of the fusion masks across frames, allowing for smooth transitions between different processing states. Temporal interpolation between key frame states enables fluid movement of restoration effects. Furthermore, the system incorporates motion-aware smoothing that accounts for object movement, ensuring that restored regions properly track with moving elements in the video. These approaches are complemented by adaptive temporal filtering that adjusts based on content characteristics, providing optimal smoothing for different types of video content.

The incorporation of temporal smoothing provides significant advantages for video processing applications. By ensuring smooth transitions of restored regions across frame sequences, the system maintains visual consistency throughout the video duration and effectively reduces temporal artifacts that might otherwise appear when processing frames independently. The system can maintain temporal coherence of the restored content, creating a more professional and polished final result.

The system may incorporate comprehensive scalability features in its temporal smoothing implementation. It can dynamically adjust temporal smoothing parameters based on the specific video content type and motion characteristics present in the sequence. The processing can adapt to meet various time constraints while maintaining quality standards. This flexibility extends to managing available computational resources efficiently, allowing the system to optimize performance based on hardware capabilities. Furthermore, the system accommodates specific temporal effects desired in the final output, such as customizable fade-in durations and transition styles.

The temporal fusion masks can be generated with varying degrees of smoothness and transition speeds, enabling the system to adapt to different video processing requirements while maintaining efficient use of computational resources. This adaptability ensures that the system can provide optimal results across a wide range of video processing applications while preserving the benefits of ROI-based processing approach.

In various implementations, the sequence of operations may be modified such that the content parsing and fusion mask generation precede the ROI restoration process, similar to previously described embodiments. The particular ordering of these operations represents one possible implementation, and the invention encompasses other sequences and combinations of these processing steps.

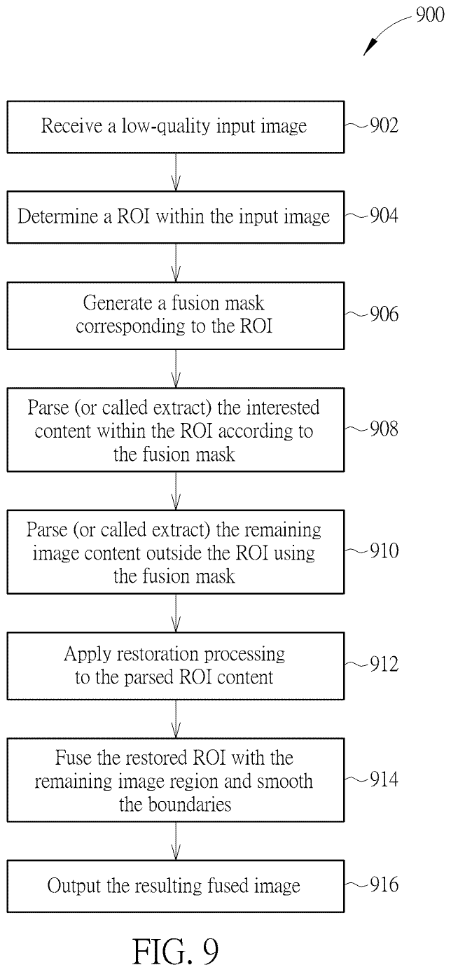

FIG. 9 is a flowchart illustrating a method 900 of image processing according to the embodiments. The method 900 includes the following steps:
S902: Receive a low-quality input image;
S904: determine a ROI within the input image;
S906: Generate a fusion mask corresponding to the ROI.
S908: Parse (or called extract) the interested content within the ROI according to the fusion mask;
S910: Parse (or called extract) the remaining image content outside the ROI using the fusion mask;
S912: Apply restoration processing to the parsed ROI content;
S914: Fuse the restored ROI with the remaining image region and smooth the boundaries;
S916: Output the resulting fused image.

At step S902, the system receives a low-quality input image requiring restoration processing. The input image may be received from various sources, including but not limited to, an image sensor, a storage device, or a network transmission. At step S904, the system analyzes application requirements to determine an appropriate region of interest (ROI) within the input image. This analysis considers factors such as computational resources, quality requirements, and specific content characteristics to identify the most critical areas requiring restoration.

At step S906, the system generates a fusion mask corresponding to the ROI. The fusion mask defines the spatial boundaries and transition regions that will be used during the subsequent fusion process, ensuring smooth integration between processed and unprocessed regions. At step S908, the system performs content parsing within the ROI based on the generated fusion mask. This parsing operation analyzes the content characteristics within the ROI to determine appropriate restoration parameters and processing requirements for the selected region.

At step S910, the system performs parsing of the remaining content based on the fusion mask. This step analyzes the characteristics of regions outside the ROI to ensure proper integration during the subsequent fusion process and maintain overall image consistency. At step S912, the system applies restoration processing to the parsed content within the ROI. This restoration operation enhances the quality of the selected region while maintaining computational efficiency by focusing processing resources on the most critical areas.

At step S914, the system performs fusion of the restored image content with the remaining region while implementing boundary smoothing operations. This fusion process utilizes the previously generated mask to create seamless transitions between restored and unrestored regions, ensuring natural-looking results. At step S916, the system outputs the final fused image, which combines the enhanced ROI with the original remaining regions in a visually cohesive manner. The output image maintains high quality in critical regions while ensuring efficient use of processing resources.

In certain implementations, multitasking and parallel processing capabilities may be advantageously utilized to optimize processing efficiency and resource utilization. The above process steps may be executed in different orders or simultaneously, subject to certain dependency constraints, to achieve improved performance and reduced processing time.

For example, after receiving the low-quality input image (S902), multiple processing paths may be executed concurrently. The ROI analysis (S904) and fusion mask generation (S906) may be performed in parallel, as these operations can operate independently on the input image data. This parallel execution reduces the overall processing latency compared to strictly sequential processing.

Furthermore, the content parsing operations for both the ROI (S908) and remaining regions (S910) may be executed simultaneously once the fusion mask is available. These parsing operations are independent of each other and can be distributed across multiple processing units or threads. This parallel parsing approach is particularly beneficial when processing large images or when multiple ROIs are present.

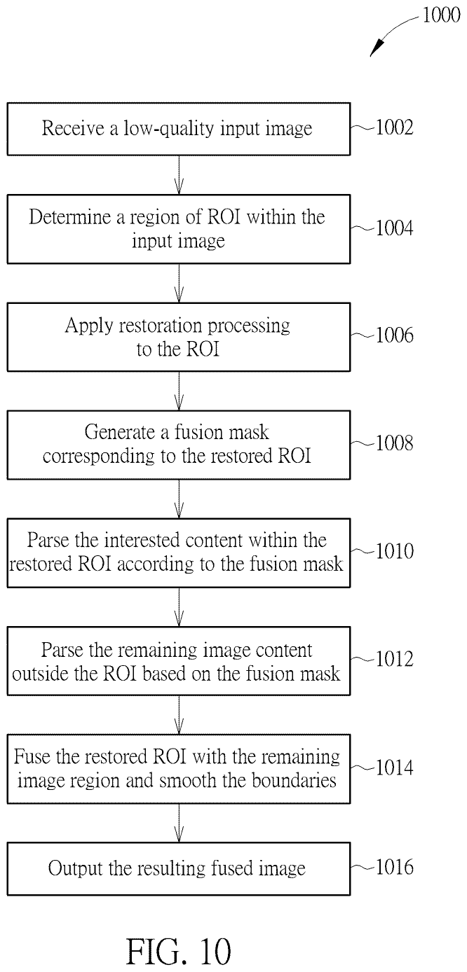

FIG. 10 is a flowchart illustrating an alternative method 1000 of image processing according to the embodiments. The method 1000 includes the following steps:
S1002: Receive a low-quality input image;
S1004: Determine a region of ROI within the input image;
S1006: Apply restoration processing to the ROI;
S1008: Generate a fusion mask corresponding to the restored ROI;
S1010: Parse the interested content within the restored ROI according to the fusion mask;
S1012: Parse the remaining image content outside the ROI based on the fusion mask;
S1014: Fuse the restored ROI with the remaining image region and smooth the boundaries;
S1016: Output the resulting fused image.

In certain implementations, multitasking and parallel processing capabilities may be advantageously utilized to optimize processing efficiency and resource utilization. The above process steps may be executed in different orders or simultaneously, subject to certain dependency constraints, to achieve improved performance and reduced processing time. As the operational details of these steps correspond to those detailed in the foregoing embodiment, further elaboration is omitted for brevity.

In this specification, the interested content within the ROI refers to specific features, characteristics, or elements that are significant for the restoration and fusion processes. In one embodiment, the interested content comprises various structural elements within the ROI, including edge information and boundary characteristics, texture patterns and local texture features, object contours and silhouettes, semantic content such as facial features, text, or specific objects. Additionally, the interested content encompasses color distributions and gradients, local contrast variations, and intensity transitions and patterns throughout the ROI.

The parsed interested content directly influences the generation of fusion masks in several ways. For facial content, the fusion mask may follow natural facial contours, while for structural content, the mask may align with architectural or geometric edges. In regions containing textures, the mask may follow texture flow patterns, and for natural objects, the mask may conform to organic boundaries to maintain visual consistency.

In one implementation, the fusion mask generation process utilizes the parsed interested content through multiple mechanisms. The process determines optimal blending boundaries that follow natural content transitions and identifies regions requiring gradual versus sharp transitions. It also adapts fusion parameters based on content characteristics and creates content-aware smoothing patterns for mask edges. Furthermore, the process generates spatially varying blending weights based on content properties to ensure seamless integration.

When processing facial features as interested content, the fusion mask generation system employs specialized techniques. The system is designed to follow natural facial contours around eyes, nose, and mouth while maintaining consistent skin texture transitions. It preserves important facial feature boundaries and ensures smooth blending in areas of gradual tone variation, resulting in natural-looking restored facial images.

For structural elements within the interested content, the fusion mask implements specific handling methods. The system aligns the mask with architectural edges and corners while preserving geometric patterns and symmetry. It maintains straight line continuity throughout the fusion region and ensures proper handling of perspective and depth cues, which is crucial for maintaining the structural integrity of the restored image.

In video applications, the parsed interested content guides temporal aspects of fusion through several mechanisms. The system actively tracks content movement across frames and maintains temporal consistency in fusion boundaries. It continuously adapts to dynamic content changes and ensures smooth transitions in time-varying content, which is essential for maintaining visual quality in video sequences.

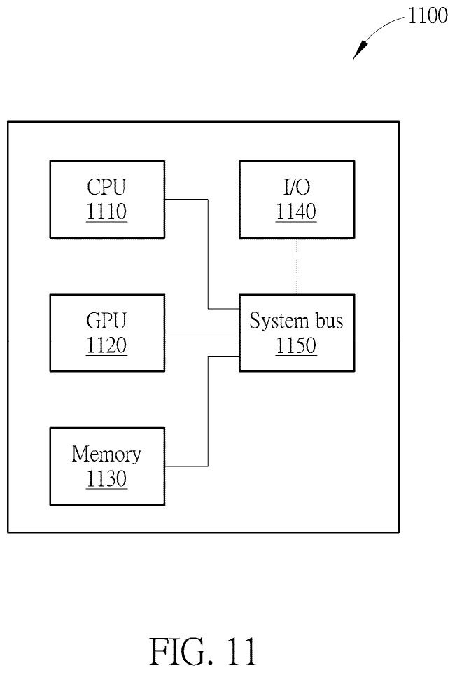

FIG. 11 depicts a block diagram of an image processing apparatus 1100 according to the embodiments. The image processing apparatus 1100 includes a central processing unit (CPU) 1110, a graphics processing unit (GPU) 1120, a memory 1130, and an input/output (I/O) interface 1140, all of which are interconnected via a system bus 1150. The image processing apparatus 1100 serves as the system for performing the above described methods.

The CPU 1110 serves as the main processing unit of the apparatus 1100, controlling the overall operation and executing program instructions for ROI-based image restoration. The GPU 1120 is used to perform parallel processing tasks, particularly suited for image processing operations including restoration and fusion calculations.

The memory 1130 is coupled to the system bus 1150 and provides storage for program instructions, input images, intermediate processing results, and output data. The memory 1130 may include various types of memory devices, such as random access memory (RAM), read-only memory (ROM), or other suitable storage devices.

The I/O interface 1140 is coupled to the system bus 1150 and handles data input and output operations. The I/O interface 1140 enables the apparatus 1100 to receive input images for processing and output restored images after processing is complete.

The system bus 1150 serves as the communication backbone of the apparatus 1100, facilitating data transfer between the various components. The system bus 1150 may include data lines for transferring data, address lines for signaling data destinations, and control lines for coordinating and controlling the various components.

Through this architecture, the image processing apparatus 1100 efficiently implements the ROI-based image restoration method with content smart fusion. The CPU 1110 and GPU 1120 work cooperatively to process images, with the memory 1130 providing necessary storage and the I/O interface 1140 managing external communications. This configuration enables efficient processing while maintaining flexibility for various application requirements.

The disclosed method provides several significant advantages over other image restoration approaches. Firstly, it reduces computational resource requirements by processing only regions of interest (ROIs) rather than the entire image. This targeted approach substantially decreases processing time and computational overhead while maintaining high-quality results in visually important areas. By focusing restoration efforts exclusively on ROIs, the system can achieve optimal resource allocation and faster processing speeds compared to full-image restoration methods.

In addition, the method offers exceptional scalability through its flexible architecture. The system can dynamically adjust the number of ROIs, fusion methods, and processing parameters according to different application requirements. This adaptability enables the invention to efficiently handle various use cases, from simple single-ROI processing to complex multi-ROI scenarios with different fusion requirements, all while maintaining optimal performance.

For video applications, the method maintains temporal consistency through sophisticated fusion mask generation and smoothing techniques. This ensures stable and natural-looking results across video frames, avoiding flickering or temporal artifacts that often plague conventional frame-by-frame processing methods.

These advantages collectively make the disclosed method a superior solution for image and video restoration applications, offering an optimal combination of computational efficiency, visual quality, and implementation flexibility. The ability to maintain high-quality results while significantly reducing computational overhead represents a substantial advancement in the field of image processing.

The terminology employed in the description of the various embodiments herein is intended for the purpose of describing particular embodiments and should not be construed as limiting. In the context of this description and the appended claims, the singular forms “a”, “an”, and “the” are intended to encompass plural forms as well, unless the context clearly indicates otherwise.

It should be understood that the term “and/or” as used herein is intended to encompass any and all possible combinations of one or more of the associated listed items. Furthermore, it should be noted that the terms “includes,” “including,” “comprises,” and/or “comprising,” when used in this specification, indicate the presence of stated features, integers, steps, operations, elements, and/or components, but do not exclude the presence or addition of one or more other features, integers, steps, operations, elements, components, and/or groups thereof.

The use of ordinal designators like “first,” “second,” and so forth in the specification and claims serves to differentiate between multiple instances of similarly named elements. These designators do not imply any inherent sequence, priority, or chronological order in the manufacturing process or functional relationship between elements. Rather, they are employed solely as a means of uniquely identifying and distinguishing between separate instances of elements that share a common name or description.

Unless specifically stated otherwise, the term “some” refers to one or more. Various combinations using “at least one of” or “one or more of” followed by a list (e.g., A, B, or C) should be interpreted to include any combination of the listed items, including individual items and multiple items.

Terms such as “coupled,” “connected,” “connecting,” and “electrically connected” are used synonymously to describe a state of being linked together through physical wires or wireless connections to enable electrical or electronic communications. When an entity is described as being in “communication” with another entity or entities, it implies the capability of sending and/or receiving electrical signals, which may contain data/control information, regardless of whether these signals are analog or digital in nature.

As may be used throughout this specification and the appended claims, terms of approximation and degree such as “substantially,” “approximately,” “generally,” “essentially,” “nearly,” “about,” and similar expressions are used to account for variations in precision, manufacturing tolerances, measurement accuracy, environmental conditions, and inherent material properties that may affect the described features or characteristics. Such variations may range from ±20% in broader applications to progressively tighter tolerances of ±10%, ±5%, ±3%, ±2%, ±1%, or ±0.5% in more precise implementations. The specific degree of variation encompassed by these terms of approximation in any given context is informed by the nature of the component, relationship, or parameter being described, the technical requirements of the particular embodiment, and the understanding of one skilled in the relevant art.

This interpretation of terminology is provided to ensure clarity and consistency throughout the specification and claims, and should not be construed as restricting the scope of the disclosed embodiments or the appended claims.

The various illustrative components, logic, logical blocks, modules, circuits, operations and algorithm processes described in connection with the embodiments disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus utilized to implement the various illustrative components, logics, logical blocks, modules, and circuits described herein may comprise, without limitation, one or more of the following: a general-purpose single-chip or multi-chip processor, a graphics processing unit (GPU), a tensor processing unit (TPU), a neural network processing unit (NPU), a digital signal processor (DSP), an application specific integrated circuit (ASIC), a field programmable gate array (FPGA), other programmable logic devices (PLDs), discrete gate or transistor logic, discrete hardware components, any suitable combination thereof. Such hardware and apparatus shall be configured to perform the functions described herein.

A general-purpose processor may include, but is not limited to, a central processing unit (CPU), a microprocessor, or alternatively, any conventional processor, controller, microcontroller or state machine. In certain implementations, a processor may be realized as a combination of computing devices. Such combinations may include, for example, a DSP and a microprocessor, a plurality of microprocessors, one or more microprocessors in conjunction with a DSP core, or any other such configuration as may be suitable for the intended application.

It is to be understood that in some embodiments, particular processes, operations, or methods may be executed by circuitry specifically designed for a given function. Such function-specific circuitry may be optimized to enhance performance, efficiency, or other relevant metrics for the particular task at hand. The selection of specific hardware implementation shall be determined based on the particular requirements of the application, which may include, inter alia, performance specifications, power consumption constraints, cost considerations, and size limitations.

In certain aspects, the subject matter described herein may be implemented as software. Specifically, various functions of the disclosed components, or steps of the methods, operations, processes, or algorithms described herein, may be realized as one or more modules within one or more computer programs. These computer programs may comprise non-transitory processor-executable or computer-executable instructions, encoded on one or more tangible processor-readable or computer-readable storage media. Such instructions are configured for execution by, or to control the operation of, data processing apparatus, including the components of the devices described herein. The aforementioned storage media may include, but are not limited to, RAM, ROM, EEPROM, CD-ROM or other optical disk storage, magnetic disk storage or other magnetic storage devices, or any other medium capable of storing program code in the form of instructions or data structures. It should be understood that combinations of the above-mentioned storage media are also contemplated within the scope of computer-readable storage media for the purposes of this disclosure.

Various modifications to the embodiments described in this disclosure may be readily apparent to persons having ordinary skill in the art, and the generic principles defined herein may be applied to other embodiments without departing from the spirit or scope of this disclosure. Thus, the claims are not intended to be limited to the embodiments shown herein, but are to be accorded the widest scope consistent with this disclosure, the principles and the novel features disclosed herein.

In certain implementations, the embodiments may comprise the disclosed features and may optionally include additional features not explicitly described herein. Conversely, alternative implementations may be characterized by the substantial or complete absence of non-disclosed elements. For the avoidance of doubt, it should be understood that in some embodiments, non-disclosed elements may be intentionally omitted, either partially or entirely, without departing from the scope of the invention. Such omissions of non-disclosed elements shall not be construed as limiting the breadth of the claimed subject matter, provided that the explicitly disclosed features are present in the embodiment.

Additionally, various features that are described in this specification in the context of separate embodiments also can be implemented in combination in a single implementation. Conversely, various features that are described in the context of a single implementation also can be implemented in multiple embodiments separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

The depiction of operations in a particular sequence in the drawings should not be construed as a requirement for strict adherence to that order in practice, nor should it imply that all illustrated operations must be performed to achieve the desired results. The schematic flow diagrams may represent example processes, but it should be understood that additional, unillustrated operations may be incorporated at various points within the depicted sequence. Such additional operations may occur before, after, simultaneously with, or between any of the illustrated operations.

Additionally, it should be understood that the various figures and component diagrams presented and discussed within this document are provided for illustrative purposes only and are not drawn to scale. These visual representations are intended to facilitate understanding of the described embodiments and should not be construed as precise technical drawings or limiting the scope of the invention to the specific arrangements depicted.

In certain implementations, multitasking and parallel processing may prove advantageous. Furthermore, while various system components are described as separate entities in some embodiments, this separation should not be interpreted as mandatory for all embodiments. It is contemplated that the described program components and systems may be integrated into a single software package or distributed across multiple software packages, as dictated by the specific implementation requirements.

It should be noted that other embodiments, beyond those explicitly described, fall within the scope of the appended claims. The actions specified in the claims may, in some instances, be performed in an order different from that in which they are presented, while still achieving the desired outcomes. This flexibility in execution order is an inherent aspect of the claimed processes and should be considered within the scope of the invention.

While the invention has been described in connection with certain embodiments, it will be understood by those skilled in the art that various modifications and adaptations can be made without departing from the scope of the invention. The specific embodiments presented are intended to illustrate the invention and not to limit its application or construction. Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of image processing, performed by a processor, comprising:
extracting at least one region of interest (ROI) from an image;
performing image restoration processing on the extracted at least one ROI to generate at least one restored ROI, wherein there is at least one region of the image outside the at least one ROI being remaining region;
generating at least one fusion mask according to the at least one ROI; and
performing fusion of the at least one restored ROI with the remaining region using the at least one fusion mask to generate a fused image.

2. The method of claim 1, further comprising:
outputting the fused image to a display device.

3. The method of claim 1, further comprising determining a location of the at least one ROI within the image prior to extracting the at least one ROI from the image.

4. The method of claim 1, wherein the at least one fusion mask is generated according to content parsing of the at least one ROI, a low quality image, a low quality ROI and/or a restored ROI.

5. The method of claim 1, wherein performing fusion comprises performing alpha blending fusion between the at least one restored ROI and the remaining region.

6. The method of claim 1, wherein performing fusion comprises:
generating a plurality of pyramid levels for the at least one restored ROI and the remaining region;
performing fusion at each pyramid level to generate a plurality of fused pyramid levels; and
reconstructing the fused image from the fused pyramid levels.

7. The method of claim 1, wherein performing fusion comprises performing fusion in at least one of:
a YUV color space domain;
a RGB color space domain;
a frequency domain; and
a hybrid domain combining a plurality of color channels.

8. The method of claim 1, wherein the at least one fusion mask is processed using at least one of:
spatial smoothing; and
temporal smoothing across a plurality of frames.

9. The method of claim 1, wherein the at least one ROI comprises a plurality of ROIs, and wherein the at least one fusion mask comprises a plurality of instance-specific fusion masks corresponding to the plurality of ROIs.

10. The method of claim 9, wherein performing fusion comprises performing depth-based fusion of the plurality of ROIs from far to near depth positions.

11. An image processing apparatus, comprising one or more processors configured to:
extract at least one region of interest (ROI) from an image;
perform image restoration processing on the extracted at least one ROI to generate at least one restored ROI;
generate at least one fusion mask according to the at least one ROI; and
perform fusion of the at least one restored ROI with a remaining region using the at least one fusion mask to generate a fused image,
wherein there is at least one region of the image outside the at least one ROI being the remaining region, and the remaining region is maintained without restoration processing.

12. The image processing apparatus of claim 11, wherein the one or more processors are further configured to:
output the fused image to a display device.

13. The image processing apparatus of claim 11, wherein the one or more processors are further configured to determine a location of the at least one ROI within the image prior to extracting the at least one ROI from the image.

14. The image processing apparatus of claim 11, wherein the at least one fusion mask is generated according to content parsing of the at least one ROI, a low quality image, a low quality ROI and/or a restored ROI.

15. The image processing apparatus of claim 11, wherein the one or more processors are configured to perform the fusion by performing alpha blending fusion between the at least one restored ROI and the remaining region.

16. The image processing apparatus of claim 11, wherein the one or more processors are configured to perform the fusion by:
generating a plurality of pyramid levels for the at least one restored ROI and the remaining regions;
performing fusion at each pyramid level; and
reconstructing the fused image from the fused pyramid levels.

17. The image processing apparatus of claim 11, wherein the one or more processors are configured to perform in at least one of:
a YUV color space domain;
a RGB color space domain;
a frequency domain; and
a hybrid domain combining a plurality of color channels.

18. The image processing apparatus of claim 11, wherein the one or more processors are configured to process the at least one fusion mask using at least one of:
spatial smoothing; and
temporal smoothing across a plurality of frames.

19. The image processing apparatus of claim 11, wherein:
the at least one ROI comprises a plurality of ROIs; and
wherein the at least one fusion mask comprises a plurality of instance-specific fusion masks corresponding to the plurality of ROIs.

20. The image processing apparatus of claim 19, wherein the one or more processors are configured to perform the fusion by performing depth-based fusion of the plurality of ROIs from far to near depth positions.

21. A non-transitory computer-readable medium comprising instructions that, when executed by a processor, perform operations of:
extracting at least one region of interest (ROI) from an image;
performing image restoration processing on the extracted at least one ROI to generate at least one restored ROI, wherein there is at least one region of the image outside the at least one ROI being remaining regions;
generating at least one fusion mask according to the at least one ROI; and
performing fusion of the at least one restored ROI with the remaining regions using the at least one fusion mask to generate a fused image.
